(19) United States
(12) Patent Application Publication
(10) Pub. No.: US 2008/0313043 A1
(43) Pub. Date: Dec. 18, 2008

(54) Method and System for Advertising a Product or Service

(76) Inventors: Noah Axler, Maple Glen, PA (US); Marc Segal, Maple Glen, PA (US)

Correspondence Address: Marc Segal, 1609 Brittany Drive, Maple Glen, PA, 19002, US

(21) Appl. No.: 12/140,218

(22) Filed: Jun. 16, 2008

Related U.S. Application Data
(60) Provisional application No. 60/944,627, filed on Jun. 18, 2007.

(51) Int. Cl. G06Q 30/00

(52) U.S. Cl. 705/14

(57) ABSTRACT

The present invention provides a method of advertising a product or a service. The method involves distributing an advertisement to a viewer, wherein the advertisement includes an embedded code. In a typical embodiment, the viewer would view the advertisement, take note of the embedded code, and send the code to the advertisers or third-party administrator. In response to receiving the code, the advertiser or third-party administrator would distribute a voucher to the viewer.

### CROSS REFERENCE TO RELATED APPLICATIONS

This application claims priority from U.S. application No. 60/944,627 filed Jun. 18, 2007, which is incorporated by reference in its entirety.

### BACKGROUND OF THE INVENTION

The present invention relates generally to a method of advertising including confirming the viewing of such advertisement by a consumer and rewarding the consumer for such viewing.

Advertising is generally considered to encompass all forms of promotional communication, but most people associate advertising with paid communications conveyed by a mass medium. Every major medium is used to deliver these messages, including: television, radio, movies, magazines, newspapers, the Internet, and billboards. Advertisements are usually placed anywhere an audience can easily and/or frequently access visuals and/or audio.

According to TNS Media Intelligence, in the United States alone in 2005, spending on advertising reached $144.32 billion. That same year, according to a report titled Global Entertainment and Media Outlook: 2006-2010 issued by global accounting firm PricewaterhouseCoopers, worldwide advertising spending was $385 billion. The accounting firm's report projected worldwide advertisement spending to exceed half-a-trillion dollars by 2010.

Television advertising is a very effective way to deliver a powerful message about a product or service to the widest audience possible. The impact of an audio-visual message is generally considered more likely to capture and hold an audience s attention more than a visual or audio message alone. The problem with television advertising is that it is very expensive. Not only is the time expensive, the production costs of a television commercial can be extremely expensive. Because of these costs, advertisers want to maximize the number of consumers that view their commercials.

Historically, television shows were generally watched at their scheduled times. These television shows contained commercial breaks in which a number of 15 or 30 second commercials were shown. Accordingly, unless the viewer changed channels or left the room, viewers of the television show were generally exposed to the commercials during these breaks. While no doubt a number of people still watch television in this manner, because of changing viewing habits a number of viewers are not being exposed to the commercials. With the advent of digital video recorders (e.g., Tivo), streaming video on the internet, downloadable programming, movies and television shows on demand, television advertisers have seen their audience shrink or, worse, gain the ability to simply skip over television commercials. As noted in the December 2006 issue of Wired magazine: Without being overly simplistic or melodramatic, the state of the Old Commercial Broadcasting Model can be summarized like this: a spiraling vortex of ruin. Fragmentation has decimated audiences, viewers who do watch are skipping commercials, advertisers are therefore fleeing, the revenue for underwriting new content is therefore flatlining, program quality is therefore suffering . . . which will lead to ever more viewer defection, which will lead to ever more advertiser defection, and so on.

Thus, the problem for would-be television advertisers is simple: how to get people to watch commercials. An effective solution to this problem is to reward the audience for watching the commercials. While this solution could be cost-prohibitive in some applications, it need not be. The invention describes a method by which television advertisers can simply and effectively deliver their commercials to an established audience in a cost-effective manner.

### SUMMARY OF THE INVENTION

The present invention provides a method of advertising a product or a service. The method involves distributing an advertisement for a product or service to a viewer. The advertisement may be distributed, for example, on DVD via mail, video-on-demand, digital download or e-mail. In an embodiment of the present invention, the advertisement is distributed on a DVD along with a rented DVD or a rented computer game. The advertisement may be selected based upon certain demographic or consumer profiles. The advertisement includes an embedded code which will be used to confirm viewing of the advertisement. In a typical embodiment, the viewer would view the advertisement and take note of the embedded code. The viewer would then send the code to the advertisers or third-party administrator who would receive the code. In response to receiving the code and thus as a reward for viewing the advertisement, the advertiser or third-party administrator would distribute a voucher to the viewer. The voucher would typically allow for the purchase of discounted goods or services.

The present invention also provides a computer system for advertising a product or service. The computer system includes a processor; a memory operably connected to the processor; and instructions stored in the memory and executable by the processor. The instructions cause the computer system to distribute an advertisement for a product or a service to a viewer, wherein the advertisement includes an embedded code; receive the embedded code from the viewer; and distribute a voucher in response to receiving the code from the viewer

### BRIEF DESCRIPTION OF THE DRAWINGS

FIG. 1 is a flow diagram illustrating an exemplary method of advertising a product or service, in accordance with the present invention, shown from the marketer s perspective.

FIG. 2 is a flow diagram illustrating an exemplary method of advertising a product or service, in accordance with the present invention, shown from the viewer s perspective.

FIG. 3 is a block diagram of a computer system of the present invention.

### DETAILED DESCRIPTION

The present invention provides a method of advertising a product or a service by distributing an advertisement that contains an embedded code. The advertisement is viewed and the code is noted by the consumer. The consumer can then use this code to receive a voucher for coupons or discounted goods or services.

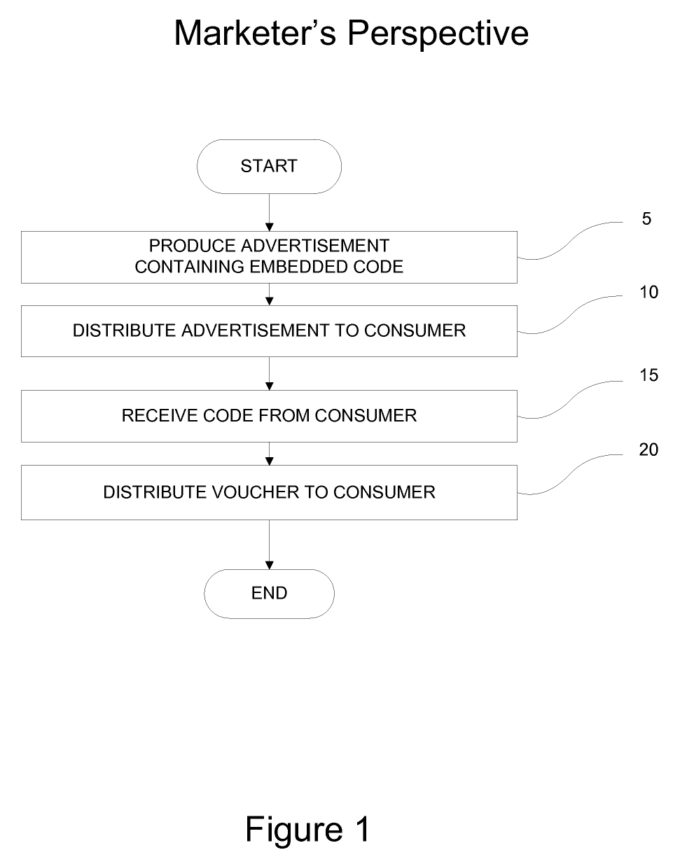

Referring to FIG. 1 which shows the method of the present invention from the marketer s perspective, the marketer first produces an advertisement containing an embedded code as shown at step 5. The term marketer refers to either the seller of the product or the service advertised, a third-party that acts to administer the method, or a seller of a different product or service for which the seller of the advertised product has entered into a joint marketing venture. Typically, the marketer does not produce the advertisement but rather retains the services of an advertising agency.

The advertisement can be any type of advertisement that is known in the art. Exemplary forms of advertisements include static images, audio only advertisements, and audiovisual or video advertisements. In an embodiment of the invention, the advertisements can be the typical 15 second or 30 second video commercial or they can be longer types of video programs that include a more in depth explanation of the product or service so called infomercials. Also contemplated by the present invention are videos with a dramatic story line (comedies, dramas, etc.) that include product placements in which a product or service is introduced into the story line of the video. For example, the product placement may involve a character wearing a product intended to be marketed to the viewer. Other product placements could involve a product appearing in the background of a scene.

The embedded code can be any code that can be recognized by the viewer of the advertisement and that can be readily transmitted back to the marketer. For example, the embedded code can be a string of alpha-numeric characters. The code can be placed anywhere in the advertisement as long as it is viewable by the viewer. For example, the code can be placed at the end of a video advertisement to help ensure that the entire advertisement is watched by the viewer. In another embodiment, the code is randomized as to location in the advertisement. As further assurance that the entire video advertisement is watched by the viewer, the video can be designed to prevent fast-forwarding.

The embedded code may include codes that are an integral part of the advertisement. The advertisement may be provided with rules which instruct the viewer where to find the codes in the advertisement. For example, the integral codes may be a particular word or phrase of dialogue from the advertisement/show or may include the color or type of some object in the advertisement.

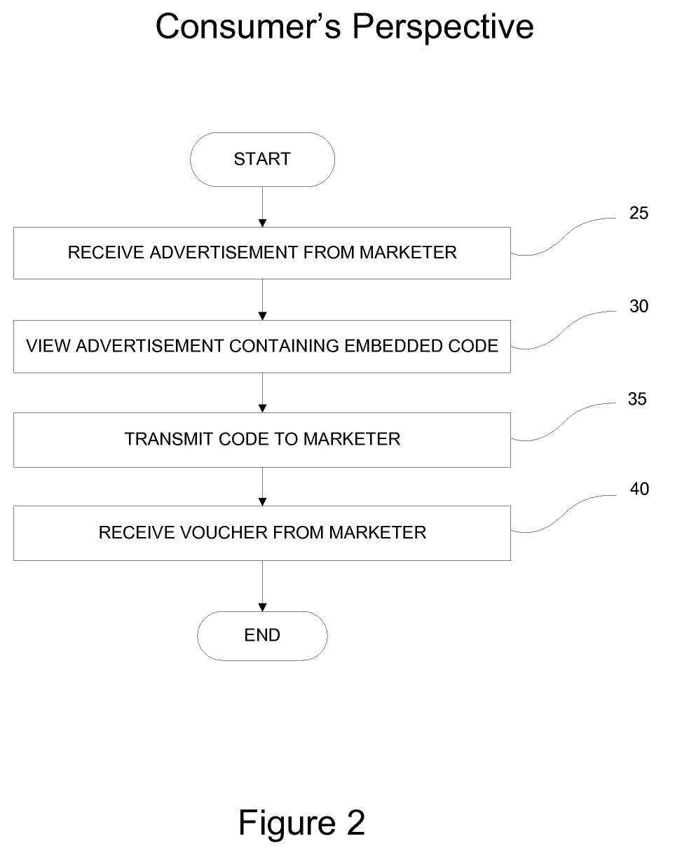

The marketer then distributes the advertisement to a consumer, as shown in step 10 of FIG. 1. From the consumer s perspective, the advertisement is received from the marketer, as shown in step 25 of FIG. 2. The distribution of the advertisement from the marketer to the consumer can be achieved in a number of ways.

For example, the advertisement can be made available for download or streaming over the internet. Methods for making available content for downloading or streaming are well-know in the art. The advertisement may be placed on the marketer s website or a third-party website. To improve the chances that consumers will be interested in the marketer s product, the downloadable advertisement can be made available on websites that contain content that is related to the marketer s product or service. The downloadable advertisement may also be made available on websites that are known for downloadable or streaming video content such as www.itunes.com or www.youtube.com. In this particular embodiment, the consumer would download the video onto their personal computer or initiate a streaming video by clicking on the desired advertisement on the website. Alternatively, the advertisements could be appended to the beginning, middle or end of the downloadable or streaming videos found on these websites. Preferably, the websites contain instructions/enticements for downloading/viewing the advertisement, recognizing and noting the code, and for redeeming the code for vouchers.

In another embodiment of the present invention, the advertisement is distributed by video-on-demand systems. Video on demand (VOD), sometimes called audio video on demand (AVOD), systems allow users to select and watch/listen to video and/or audio content on demand. VOD systems either stream content through a set-top box, allowing viewing in real time, or download it to a device such as a computer, digital video recorder, personal video recorder or portable media player for viewing at any time. The majority of cable and telecommunications based television providers offer these services. In this particular embodiment, the advertisement may be placed on a cable and/or telecommunications provider s VOD menu whereby cosumers can browse through advertisements, select an advertisement, and stream or download the advertisement for viewing.

In an embodiment of the present invention, the advertisement is distributed on a DVD directly to the consumer. In this embodiment, the DVD may be distributed in a public place, e.g., at the marketer s retail location or it can be distributed by direct mail. If direct mail is used, the advertisement can be distributed to a targeted audience by using a mailing list that contains addressees with the desired demographics.

In another embodiment of the invention, the DVD containing the advertisement is distributed along with a rented DVD (e.g., containing a movie, television show, etc.) or a rented computer game. The advertisement can be on a separate DVD or recorded on the same DVD that contains the rented program material. Website-enabled services for renting movies, television shows, etc. on DVD such as www.netflix.com and www.blockbuster.com are well known. These services allow users to list desired DVDs in a queue on a personalized account. The desired DVDs are then mailed to the user in the order in which they are listed. When a user sends back a DVD, the service mails the next DVD in the list. These services also typically personalize their website based on the user s account. Accordingly, it would require very little additional effort and expense for these services to include an additional DVD containing the advertisement with the rented DVD for mailing to the user of these services. Moreover, the advertisement selected to be distributed can be chosen based on the type of movie rented by the user of these services or the user s rental history. Preferably, the DVD would also be accompanied by instructions/enticements for viewing the advertisement, recognizing and noting the code, and for redeeming the code for vouchers. Alternatively, the advertisements could be made available for download or streaming by placing such advertisements and instructions/enticements on the services website which has been personalized based on the user s account.

Referring to FIG. 2, the consumer views the advertisement and notes the embedded code, as shown in step 30. If, as discussed above, the advertisement was distributed by download, the consumer would typically launch a video/audio player program on their personal computer such as Windows Media Player or Real Player to watch the advertisement. If the advertisement is distributed by streaming video, as discussed above, the advertisement is again viewed on the consumer s personal computer. In an embodiment of the invention, the consumer would receive the advertisement on DVD along with a rented DVD and would view the advertisement by placing the DVD in a DVD player.

During the viewing process, the consumer will be exposed to the embedded code in the advertisement. The consumer notes this code and transmits the code to the marketer, as shown in step 35 of FIG. 2. The marketer in turn receives the embedded code, as shown in step 15 of FIG. 1. The code can be transmitted to and received by the marketer in a number of ways. For example, the code can be entered on a website designed to receive the code and transmit the code to the marketer. If the advertisement is distributed by DVD along with a rented DVD as discussed above, the code may be entered on the website of the provider of the rented DVD such as www.netflix.com and www.blockbuster.com. The rental company may then forward the code to the marketer for verification and redemption. Alternatively, the code can be mailed or e-mailed to the marketer. The code may also be transmitted via telephone by calling a number provided along with the advertisement.

The step of transmitting and receiving the code may also include transmitting and receiving demographic information regarding the consumer. Such demographic information may include the consumer s age, gender, marital status, income, hobbies, interests, television viewing habits, etc. In a further embodiment of the present invention, the method includes selecting and distributing an additional advertisement based upon the consumer s demographic information.

Referring to FIG. 1, in response to receiving the code from the consumer 15, the marketer distributes a voucher to the consumer 20. Likewise, referring to FIG. 2, the consumer receives the voucher from the marketer 40. The distribution of the voucher may be accomplished in a number of ways. For example, the voucher may be distributed by e-mail. In the preferred embodiment, the consumer s email is of record with the web enabled DVD rental services so that the voucher may be easily e-mailed to the consumer/user. Alternatively, the voucher may be mailed to the consumer. The consumer may also be instructed to download the voucher by inputting certain information such as the embedded code at the marketer s or a third party administrator s website.

The voucher may take any number of forms. In the present application, the term voucher means any type of benefit conferred on the consumer by the advertiser or third-party administrator. For example, the voucher may be redeemed for cash, credit, or free or discounted goods or services. The voucher may be a physical coupon that can be redeemed at retail establishments or online via a code printed on the coupon. The voucher may also be a code such as a string of alpha-numeric characters that can be entered to receive discounts from online retailers. In another embodiment, the voucher may be in a form of a credit that is applied directly to an online account. For example, the credit could be applied to the consumer s account for the web-enabled DVD rental service s website that sent the advertisement to the consumer.

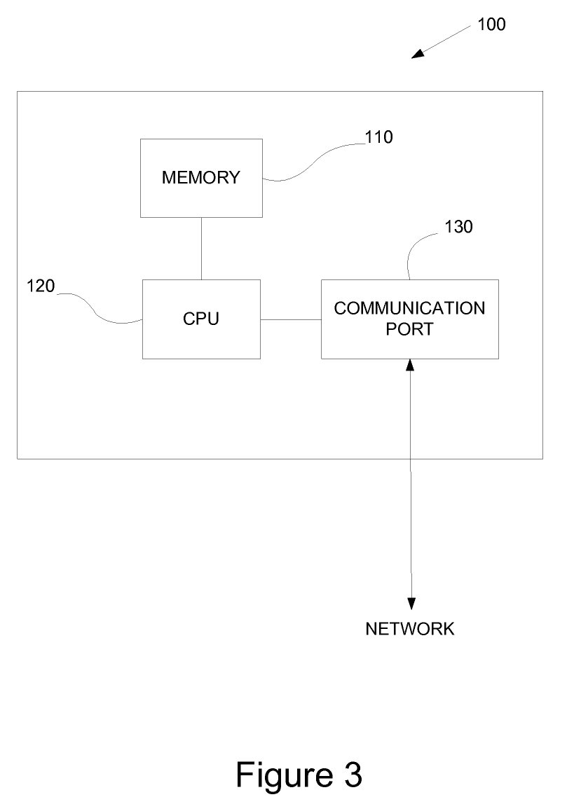

Referring to FIG. 3, the present invention also provides a computer system 100 for advertising a product or service. The computer system comprises a processor 120 and a memory 110 operably connected to the processor. The memory stores instructions that are executable by the processor to cause the system to distribute an advertisement for a product or a service to a viewer. The instructions may act in response to a request from a consumer to download or stream a particular video advertisement. In such an embodiment, the instructions direct the processor to direct a digital download or stream to the consumer s computer via a communication port 130 linked to a computer network such as the internet.

In an embodiment of the invention, the instructions act to assign a DVD containing video advertisement to be packaged and mailed with a rented DVD, for example, via website enabled DVD rental services such as www.netfix.com and www.blockbuster.com. The memory may further contain demographic information regarding the consumer including the past rental history. The instructions may be written such that this demographic information is used to assign advertisements to consumers for which they would be most receptive. Alternatively, the instructions may direct the consumer to download or stream the video from the DVD rental services website which may be personalized based on the user s account information.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. A method of advertising a product or a service comprising:
distributing an advertisement for the product or the service to a viewer, wherein the advertisement includes an embedded code for confirming viewing of the advertisement;
receiving the embedded code from the viewer;
distributing a voucher in response to receiving the code from the viewer.

2. The method of claim 1, wherein the advertisement is on a DVD.

3. The method of claim 2, wherein the DVD is distributed along with a rented DVD or a rented computer game.

4. The method of claim 3, wherein the advertisement is selected based on the rented DVD or the computer game.

5. The method of claim 2, wherein the DVD is distributed by mail using a targeted mailing list.

6. The method of claim 1, wherein the advertisement is downloaded from a website.

7. The method of claim 1, wherein the advertisement is streamed over the internet.

8. The method of claim 1, wherein the advertisement is delivered via a video-on-demand service.

9. The method of claim 1, wherein the voucher is selected from the group consisting of a coupon, a gift certificate, and a rebate certificate.

10. The method of claim 1, wherein the voucher is printable for redemption.

11. The method of claim 1, wherein the voucher comprises a code for redemption via a computer network.

12. The method of claim 1, wherein the voucher is a credit applied to an online account.

13. The method of claim 1, wherein the advertisement is a video and the code is placed at the end of the video.

14. The method of claim 13, wherein the video can not be fast-forward.

15. The method of claim 1, wherein the code is received via a computer network.

16. The method of claim 1, wherein the code is an integral part of the advertisement.

17. The method of claim 1 further comprising the steps of: receiving demographic information from the viewer.

18. The method of claim 17 further comprising the steps of selecting an additional advertisement based upon the demographic information and distributing the additional advertisement to the viewer.

19. A method of advertising a product or a service comprising:
distributing a voucher in response to receiving a code from a viewer,
wherein the code is embedded in an advertisement which has been distributed to the viewer.

20. A computer system for advertising a product or service comprising
a processor;
a memory operably connected to the processor; and
instructions stored in the memory and executable by the processor to cause said system to:
distribute an advertisement for a product or a service to a viewer, wherein the advertisement includes an embedded code;
receive the embedded code from the viewer; and
distribute a voucher in response to receiving the code from the viewer.
